(19) United States
(12) Patent Application Publication
(10) Pub. No.: US 2026/0084708 A1
(43) Pub. Date: Mar. 26, 2026

(54) SYSTEM AND METHOD FOR DATA-DRIVEN DECISION OPTIMIZATION FOR AUTONOMOUS DRIVING

(71) Applicant: SHANGHAI JIAO TONG UNIVERSITY, Shanghai (CN)

(72) Inventors: Yafei Wang, Shanghai (CN); Mingyu Wu, Shanghai (CN); Xulei Liu, Shanghai (CN); Zhisong Zhou, Shanghai (CN); Bowen Wang, Shanghai (CN)

(73) Assignee: SHANGHAI JIAO TONG UNIVERSITY, Shanghai (CN)

(21) Appl. No.: 19/404,073

(22) Filed: Dec. 1, 2025

(30) Foreign Application Priority Data
Jan. 3, 2025 (CN) 202510008226.4

(51) Int. Cl. B60W 50/06; B60W 50/00; B60W 60/00

(52) U.S. Cl. CPC B60W 50/06; B60W 50/0097; B60W 50/0098; B60W 60/0013; B60W 60/0015; B60W 60/0027; B60W 2050/0022; B60W 2050/0026; B60W 2520/10; B60W 2520/105; B60W 2552/10; B60W 2552/53; B60W 2554/402; B60W 2554/4041; B60W 2554/4042

(57) ABSTRACT

A data-driven autonomous driving decision optimization system and method, comprising: a data production module, a data screening module, a model encapsulation module, and a parameter tuning module; the data production module takes human driving data as input, annotation, preprocessing, format conversion, extracts key features and performs standardization, normalization, and encoding to generate raw data for the data-driven process that meets the algorithm input requirements; the data screening module screens corresponding data from training data by the decision-making module and performs effective classification; the model encapsulation module encapsulates C++ decision code and constructs a trajectory-pair evaluation cost map required for training using a ground-truth evaluation method based on trajectory pairs; the parameter tuning module, based on screened data under different scenarios, the encapsulated decision algorithm model, and the trajectory-pair evaluation cost map, employs black-box optimization to obtain decision parameters for the corresponding scenarios under the current decision algorithm.

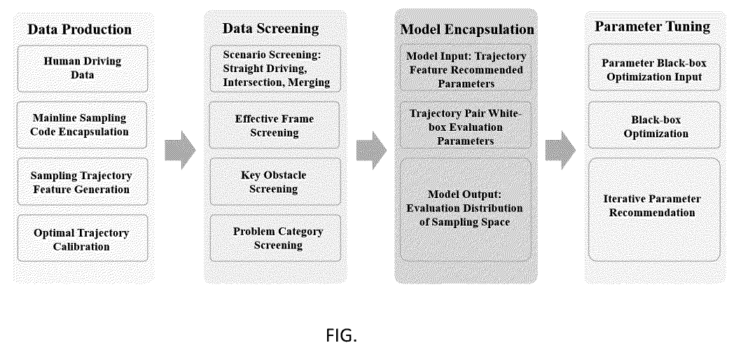

### CROSS-REFERENCE TO RELATED APPLICATIONS

This application claims priority to Chinese Patent Application Ser. No. CN202510008226.4 filed on 3 Jan. 2025.

### TECHNICAL FIELD

The present invention relates to a technology in the field of autonomous driving, and specifically to a data-driven autonomous driving decision optimization system and method.

### BACKGROUND ART

Decision-making technology is the core of intelligent driving systems, affecting safety and comfort. Existing technologies include rule-based and learning-based methods. Rule-based methods rely on empirical design of objective functions to seek optimal solutions, but the results show a significant gap compared to skilled drivers. Learning-based methods can improve decision-making outputs through model training but face issues with insufficient interpretability.

### SUMMARY OF THE INVENTION

Addressing the deficiency in existing technologies where training is limited to specific scenarios or tasks, making it difficult to handle dynamic and complex environmental changes, the present invention proposes a data-driven autonomous driving decision optimization system and method that combines rule-based and learning-based approaches, leverages large-scale data generated during autonomous-vehicle operation to enhance the performance ceiling of the decision system, thereby improving the decision-making module's performance in real-world scenarios, and constitutes a white-box data-driven decision parameter tuning technology.

The present invention is achieved through the following technical solution:

The present invention relates to a data-driven autonomous driving decision optimization system, comprising: a data production module, a data screening module, a model encapsulation module, and a parameter tuning module, wherein: the data production module takes human driving data as input, and after annotation, preprocessing, and format conversion, extracts key features and performs standardization, normalization, and encoding to generate raw data for the data-driven process that meets the algorithm input requirements; the data screening module screens corresponding data from training data according to various scenarios divided by the decision-making module and performs effective classification; the model encapsulation module encapsulates C++ decision code and constructs a trajectory-pair evaluation cost map required for training using a ground-truth evaluation method based on trajectory pairs; the parameter tuning module, based on screened data under different scenarios, the encapsulated decision algorithm model, and the trajectory-pair evaluation cost map, employs a black-box optimization method to obtain decision parameters for the corresponding scenarios under the current decision algorithm.

The human driving data are data generated by experienced drivers driving vehicles and have undergone preliminary annotation, each small dataset consists of a ten-minute driving segment, and each frame of data includes comprehensive ego-vehicle state information and surrounding environment information, including ego-vehicle position, speed, acceleration, current lane ID, lane line information, lane association information, current ego-vehicle behavior information such as left turn, straight driving, passing intersections, surrounding vehicle information such as vehicle ID, vehicle type, vehicle size, position, speed, and future trajectories predicted by the prediction module.

The raw data in the data-driven process include: ego-vehicle sampled trajectory information, surrounding vehicle sampled trajectory information, a list of vehicle IDs requiring game-theoretic interaction, ego-vehicle state information list, surrounding vehicle state information list, conflict point information, predicted ego-vehicle trajectories over a 6-second horizon, surrounding vehicle posterior trajectories within the next 6 seconds, and environment information list.

The decision scenarios include straight driving, intersection, merge-in/merge-out, and lane change scenarios.

The corresponding data are divided according to the decision scenarios and undergo data mining to obtain key data for training.

The present invention relates to an autonomous driving decision optimization method based on the above system, comprising: reading raw data, executing the decision algorithm, and setting rules to generate final data; performing data cleaning and data mining processing on the obtained data; encapsulating the decision algorithm and constructing ground truth using a sampling—objective functionobjective function—evaluation-screening decision algorithm framework; utilizing a black-box optimization method to iteratively search for the optimal parameter combination satisfying the objective functionobjective function met by the training data in the corresponding scenarios, thereby obtaining optimized autonomous driving decisions.

The data mining processing screens based on the difference in Time to Collision (TTC) between the ego vehicle and the agent vehicle at the conflict point, specifically: DTTC=TTC_{ego}−TTC_{agent}, where DTTC represents the time difference for the ego vehicle and the agent vehicle to reach the conflict point, TTC_{ego} and TTC_{agent} respectively represent the time for the ego vehicle and the agent vehicle to reach the conflict point.

The conflict point refers to the spatial intersection between the predicted trajectory of the ego vehicle and the predicted trajectory of the agent vehicle, obtained through collision detection calculations between the ego vehicle and the agent vehicle.

The encapsulation of the decision algorithm refers to: first sampling the future driving trajectories of the ego vehicle and the agent vehicle, then comprehensively evaluating the ego-vehicle and agent-vehicle sampling results according to a predefined objective function to obtain the trajectory pair that minimizes the objective function, thereby determining the yield/compete strategy between the ego vehicle and the agent vehicle.

The objective function is func=Wₛ·F_{safe}+W_{c}·F_{comfort}+Wₚ·Fₚₐₛₛ+Wᵣ·F_{right}, where F_{safe}, F_{comfort}, Fₚₐₛₛ, and F_{right} respectively represent safety, comfort, passability, and right of way, and Wₛ, W_{c}, Wₚ, Wᵣ represent the respective weights in the objective function.

The construction of ground truth, i.e., constructing the decision ground truth required during the training data construction process, is achieved by calculating the similarity of trajectory pairs and the modal similarity to determine closer trajectory pairs and driver decision results.

The similarity of trajectory pairs is measured by the final displacement error (fde), average displacement error (ade), and lateral displacement error (lde) between the sampled trajectory and the predicted trajectory, specifically using:

$$ade = \frac{1}{n} \times {\sum }_{i = 1}^{n} Δ {d}_{i} , fde = Δ {d}_{{goal}_{idx}} , lde = \frac{1}{n} \times {\sum }_{i = 1}^{n} Δ {l}_{i} ,$$

Δdas the Euclidean distance and Δl as the lateral distance in the Frenet coordinate system.

The similarity of modalities is determined based on the posterior yield/compete relationship between the ego vehicle and the agent vehicle derived from DTTC, with penalties applied to sampled results inconsistent with the posterior yield/compete relationship, thereby obtaining a ground-truth evaluation calculation method based on data and the decision algorithm framework, specifically: label_cost=W₁×ade+W₂×fde+W₃×lde+W₄×bde, where bde represents the modal difference value, and W₁, W₂, W₃, W₄ are hyperparameters.

The parameter tuning iteration process employs the Kullback-Leibler (KL) divergence loss function, specifically:

$${D}_{K} L ( p ‖ q ) = {\sum }_{i = 1}^{n} p ( {x}_{i} ) log \frac{p ( {x}_{i} )}{q ( {x}_{i} )} ,$$

where p(xᵢ) is the ground truth and q(xᵢ) is the value output by the decision algorithm.

A computer device, comprising a memory and a processor, wherein the memory stores a computer program, and the processor executes the computer program to implement the autonomous driving decision optimization method.

A non-transitory computer readable storage medium, wherein the medium stores a computer program, and the program is executed by processor to implement the autonomous driving decision optimization method.

### Technical Effects

The present invention utilizes implicit driving style features in massive human driving data, extracts parameters reflecting driving behavior patterns through offline computation and analysis, and uses them to drive dynamic parameter adjustment in the autonomous driving decision system. This method, incorporating white-box technical characteristics, internalizes the driver's operational style into interpretable algorithmic logic. By employing methods based on Time to Collision (TTC) difference and conflict point analysis, it precisely screens key moment data critical for decision-making, while generating trajectory predictions for the ego vehicle and agent vehicles. Through comprehensive evaluation of trajectory modal similarity and trajectory errors, high-quality ground truth construction is completed. On a data-driven basis, a rule-based framework is integrated to establish multi-objective functions for safety, comfort, passability, and right of way. Compared to the prior art, the present invention effectively fuses data and logic via a white-box data-driven approach combined with a rule-based framework, achieving more human-like and interpretable parameter decisions rather than relying solely on pure black-box model optimization; it enhances data processing and model training efficiency through multi-thread acceleration, conflict point analysis, and modality-based ground truth construction, representing a significant improvement over existing data-cleaning and screening processes; adopting offline parameter generation avoids instability in online real-time optimization, further ensuring system safety and reliability.

### DESCRIPTION OF DRAWINGS

FIGURE is a schematic diagram of the system of the present invention.

### DETAILED DESCRIPTION OF EMBODIMENTS

As shown in FIGURE, the present embodiment relates to a data-driven autonomous driving decision parameter adjustment system, comprising a data production module, a data screening module, a model encapsulation module, and a parameter tuning module.

The data production module comprises: a human driving data unit, a mainline sampling code encapsulation unit, a sampled trajectory feature generation unit, and an optimal trajectory calibration unit, wherein: the human driving data unit collects and integrates massive data generated by human drivers, including ego-vehicle states (position, speed, acceleration, lane information) and surrounding vehicle and environment information (vehicle ID, type, trajectory, conflict points, etc.), to capture driving styles and behavioral patterns; the mainline sampling code encapsulation unit encapsulates mainline sampling code according to data sampling rules and objective function constraints, automatically generating trajectory sampling schemes that satisfy the rules to obtain a preliminary rule-constrained sampled trajectory set; the sampled trajectory feature generation unit extracts sampled trajectory features (such as speed, acceleration, TTC difference, etc.) based on trajectory sampling results, including ego-vehicle and agent-vehicle trajectory points and interaction information, generating trajectory feature vectors for analysis to obtain sampled trajectory features for subsequent model encapsulation and evaluation; the optimal trajectory calibration unit performs multi-objective comprehensive evaluation on sampled trajectories according to trajectory features and objective function values (such as safety, comfort, etc.), calibrating optimal trajectories that satisfy objective function conditions to obtain calibrated optimal trajectories for subsequent training and validation.

The data screening module comprises: a scenario screening unit, a valid-frame screening unit, a key-obstacle screening unit, and a problem-category screening unit, wherein: the scenario screening unit classifies trajectory data into scenarios such as straight driving, intersection, merge-in/merge-out according to trajectory data and scenario classification rules, provides labels for specific scenarios to obtain classified scenario datasets as a basis for refined analysis; the valid-frame screening unit screens key frames within effective time windows based on time-related indicators (such as TTC, DTTC) (e.g., frames where DTTC is in [1.0, 3.0]), eliminating redundant information to obtain a set of valid frames in high-risk scenarios; the key-obstacle screening unit screens key obstacle information significantly impacting decision-making based on trajectory data and environment information (such as obstacle position, movement trajectory) (e.g., objects close or about to interact with the ego vehicle), obtaining a scenario data subset containing key obstacle information; the problem-category screening unit screens scenario data according to scenario features and potential problem categories (such as collision risk, overtaking behavior), focusing on solving specific driving problems to obtain high-quality training datasets optimized for problem categories.

The model encapsulation module comprises: a model input unit, a trajectory-pair white-box evaluation unit, a sampled-space evaluation distribution unit, and a model output unit, wherein: the model input unit inputs trajectory-pair features according to screened trajectory feature vectors and related parameter recommendation rules, generating a recommended parameter set adapted to the model to provide support for model accuracy and applicability; the trajectory-pair white-box evaluation unit calculates evaluation parameters for trajectory pairs using a white-box model based on trajectory-pair features and objective functions (such as trajectory similarity, modal similarity, etc.), including indicators such as FDE, ADE, LDE, obtaining trajectory-pair white-box evaluation parameters for accurate analysis of decision effects; the model output unit outputs a comprehensive evaluation distribution map of the sampled trajectory space based on white-box evaluation parameters and sampled trajectory distribution, describing the superiority/inferiority of trajectories under the objective function to obtain an evaluation distribution of the sampling space as a basis for parameter tuning.

The parameter tuning module comprises: a parameter black-box optimization input unit, a black-box optimization unit, and an iterative parameter recommendation unit, wherein: the parameter black-box optimization input unit provides initial black-box optimization input based on model input parameters and training data feature vectors as starting conditions for optimization, obtaining initial parameter configurations to initiate the optimization process; the black-box optimization unit adjusts parameters using black-box optimization algorithms (such as genetic algorithms, Bayesian optimization, etc.) according to parameter configurations and optimization objective function (KL divergence), to iteratively approach an optimal solution and obtain an optimized parameter configuration; the iterative parameter recommendation unit iteratively recommends parameter configurations based on intermediate results and evaluation indicators from black-box optimization, for adjusting parameter combinations to improve optimization efficiency and obtain a set of recommended optimized parameters.

The present embodiment provides an autonomous driving decision optimization method based on the above system, comprising:

Step 1, Data Production: reading raw data, invoking the decision algorithm, and setting rules to generate the final data, specifically including:

1.1 Generated by experienced drivers, with each data segment divided into 10-minute clips, and each frame containing the following information: ego-vehicle state (position, speed, acceleration, lane information, current behavior, etc.); surrounding vehicle information (vehicle ID, type, size, speed, predicted trajectory, etc.); conflict points, ego-vehicle and surrounding vehicles' trajectories within the next 6 seconds, environmental information, etc.

1.2 Organize and output data for training, including: sampled trajectories, key vehicle IDs, ego-vehicle and surrounding vehicles' state information, conflict point information, etc.

1.3 Enhance data production efficiency through multi-threaded operations, invoking the decision algorithm and rules to generate the final data.

Step 2, Data Screening: data cleaning and data mining processes, specifically including:

2.1 Scenario classification: preliminarily classify data according to scenarios such as straight driving, intersection, merge-in/merge-out, and further subdivide, e.g., into large-vehicle and small-vehicle cut-in scenarios for interacting vehicles.

2.2 Key frame extraction: use Time to Collision (TTC) difference to screen key frames, selecting frames where DTTC is in [−1.0, 3.0].

2.3 Conflict point identification: calculate intersections of posterior trajectories between the ego vehicle and surrounding vehicles.

Step 3, Model Encapsulation: adopt a sampling-objective function-evaluation-screening decision algorithm framework for decision algorithm encapsulation and ground-truth construction, specifically including:

3.1 Core framework: the decision algorithm is based on sampling→Objective function→evaluation→screening process; the objective function comprehensively considers factors such as safety, comfort, passability, and right of way to evaluate trajectory pairs and obtain the optimal yield/compete strategy.

3.2 Ground-truth construction method: measure trajectory pair similarity (final displacement error FDE, average displacement error ADE, lateral displacement error LDE); modal similarity: penalize deviations (BDE) between sampled results and posterior yield/compete relationships; construct the final ground-truth evaluation function for the training process.

Step 4, Utilize black-box optimization methods to iteratively search for the optimal parameter combination that satisfies the objective function met by the training data in the corresponding scenarios, specifically including:

4.1 Use screened training data and calibrated ground truth as input, iteratively searching for the optimal parameter combination via black-box optimization.

4.2 The loss function used in the training process is the KL divergence loss function:

$${D}_{K} L ( p ‖ q ) = {\sum }_{i = 1}^{n} p ( {x}_{i} ) log \frac{p ( {x}_{i} )}{q ( {x}_{i} )} ,$$

where p(xᵢ) is the ground truth, and q(xᵢ) is the value output by the decision algorithm. The entire training process employs a multi-threaded training method to improve efficiency.

Through specific practical experiments in the Simulink-Carsim-Prescan joint simulation platform environment, experimental scenarios are constructed using Prescan, vehicle dynamics models are provided by Carsim, and the algorithm is deployed in Simulink. Multi-lane, multi-vehicle high-speed dynamic scenarios, surrounding vehicle cut-in scenarios, and ego-vehicle lane-change scenarios are selected for simulation. The PHP algorithm using the present method is compared with the existing fixed-strategy uncertainty modeling method (PHP*) without the present invention in the above three types of simulation scenarios.

In the multi-lane, multi-vehicle high-speed dynamic scenario, the vehicle speed of the PHP method is significantly higher than that of PHP*, indicating that the PHP algorithm employing the decision optimization method of the present invention has higher passability. In the surrounding vehicle cut-in scenario, the PHP method performs better in comfort, with the absolute value of maximum deceleration improved by 86.5% compared to PHP*. In the ego-vehicle lane-change scenario, the PHP method exhibits superior passability, with an average speed improved by 28.5% compared to PHP*. Thus, the PHP method demonstrates higher comfort and passability in experiments, especially in handling dynamic vehicle cut-in and lane-change scenarios, verifying the effectiveness of the decision optimization method of the present invention.

Compared with the prior art, the present method comprehensively considers ego-vehicle, surrounding vehicle, and environmental information to build more realistic and detailed data inputs with more comprehensive dimensions; through conflict point analysis and predicted trajectory generation, it improves the specificity and scenario adaptability of data generation; based on TTC, DTTC, and scenario classification, it precisely extracts key frames, removes invalid data, making cleaning and screening more efficient; by integrating trajectory and modal similarity, the ground truth data better align with actual needs; using black-box optimization and KL divergence, it enhances parameter tuning efficiency to quickly obtain optimal configurations. The present method achieves significant improvements in efficiency, precision, and applicability, enabling higher performance in training data generation and algorithm optimization.

The above specific embodiments may be locally adjusted in different ways by those skilled in the art without departing from the principles and spirit of the present invention. The protection scope of the present invention is defined by the claims and is not limited by the above specific embodiments. All implementation schemes within its scope are bound by the present invention.

What is claimed is:

1. An autonomous driving decision optimization method, comprising a non-transitory computer readable medium operable on a computer with memory for the autonomous driving decision optimization method, and comprising program instructions for executing the following steps of:
reading raw data, invoking a decision algorithm, and setting rules to generate final data, and performing data cleaning and data mining on the obtained data, and
encapsulating the decision algorithm and constructing ground truth using a sampling-objective function-evaluation-screening decision algorithm framework, and
utilizing a black-box optimization method to iteratively find the optimal parameter combination that satisfies the objective function met by training data in corresponding scenarios, thereby obtaining optimized autonomous driving decisions; and
autonomous driving a vehicle based on results of the autonomous driving decision optimization method.

2. The autonomous driving decision optimization method according to claim 1, wherein the data mining processing screens based on the difference in Time to Collision (TTC) between the ego vehicle and the agent vehicle at the conflict point, specifically: DTTC=TTC_{ego}−TTC_{agent}, where DTTC represents the time difference for the ego vehicle and the agent vehicle to reach the conflict point, TTC_{ego} and TTC_{agent} respectively represent the time for the ego vehicle and the agent vehicle to reach the conflict point, and
the conflict point refers to the spatial intersection between the predicted trajectory of the ego vehicle and the predicted trajectory of the agent vehicle, obtained through collision detection calculations between the ego vehicle and the agent vehicle.

3. The autonomous driving decision optimization method according to claim 1, wherein the decision algorithm encapsulation refers to: first sampling the future driving trajectories of the ego vehicle and the agent vehicle, then comprehensively evaluating the ego vehicle sampling and agent vehicle sampling results according to a predefined objective function to obtain the trajectory pair that minimizes the objective function, thereby determining the yield/compete strategy between the ego vehicle and the agent vehicle, and
the objective function is func=Wₛ·F_{safe}+W_{c}·F_{comfort}+Wₚ·Fₚₐₛₛ+Wᵣ·F_{right}, where F_{safe}, F_{comfort}, Fₚₐₛₛ, and F_{right} respectively represent safety, comfort, passability, and right of way, and Wₛ, W_{c}, Wₚ, Wᵣ represent the respective weights in the objective function.

4. The autonomous driving decision optimization method according to claim 1, wherein the constructing the ground truth, a.k.a. constructing the decision ground truth required in the training data generation process, is achieved by calculating the similarity of trajectory pairs and the similarity of modalities to determine trajectory pairs and driver decision results that are more similar, and
the similarity of trajectory pairs is measured by the final displacement error (fde), average displacement error (ade), and lateral displacement error (lde) between the sampled trajectory and the predicted trajectory, specifically using:
$$ade = \frac{1}{n} \times {\sum }_{i = 1}^{n} Δ {d}_{i} , fde = Δ {d}_{{goal}_{idx}} , lde = \frac{1}{n} \times {\sum }_{i = 1}^{n} Δ {l}_{i} ,$$
Δd as the Euclidean distance and Δl as the lateral distance in the Frenet coordinate system, and
the similarity of modalities is determined based on the posterior yield/compete relationship between the ego vehicle and the agent vehicle derived from DTTC, with penalties applied to sampled results inconsistent with the posterior yield/compete relationship, thereby obtaining a ground-truth evaluation calculation method based on data and the decision algorithm framework, specifically: label_cost=W₁×ade+W₂×fde+W₃×lde+W₄×bde, where bde represents the modal difference value, and W₁, W₂, W₃, W₄ are hyperparameters, and
the parameter tuning iteration process employs the Kullback-Leibler (KL) divergence loss function, specifically:
$${D}_{K} L ( p ‖ q ) = {\sum }_{i = 1}^{n} p ( {x}_{i} ) log \frac{p ( {x}_{i} )}{q ( {x}_{i} )} ,$$
where p(xᵢ) is the ground truth and q(xᵢ) is the value output by the decision algorithm.

5. A data-driven autonomous driving decision optimization system based on the autonomous driving decision optimization method of claim 1, characterized in that it comprises: a data production module, a data screening module, a model encapsulation module, and a parameter tuning module, wherein:
the data production module takes human driving data as input, and after annotation, preprocessing, and format conversion, extracts key features and performs standardization, normalization, and encoding to generate raw data for the data-driven process that meets the algorithm input requirements, and
the data screening module screens corresponding data from training data according to various scenarios divided by the decision-making module and performs effective classification, and
the model encapsulation module encapsulates C++ decision code and constructs a trajectory-pair evaluation cost map required for training using a ground-truth evaluation method based on trajectory pairs, and
the parameter tuning module, based on screened data under different scenarios, the encapsulated decision algorithm model, and the trajectory-pair evaluation cost map, employs a black-box optimization method to obtain decision parameters for the corresponding scenarios under the current decision algorithm.

6. The data-driven autonomous driving decision optimization system according to claim 5, wherein the human-driving data are collected from experienced drivers and have been pre-annotated and have undergone preliminary annotation, each dataset segment comprises approximately ten minutes of driving data, and each frame of data include comprehensive ego-vehicle state information and surrounding environment information, including ego-vehicle position, speed, acceleration, current lane ID, lane line information, lane association information, current ego-vehicle behavior information such as left turn, straight driving, passing intersections, and surrounding vehicle information such as vehicle ID, vehicle type, vehicle size, position, speed, and future trajectories predicted by the prediction module, and
the raw data in the data-driven process include: ego-vehicle sampled trajectory information, surrounding vehicle sampled trajectory information, a list of vehicle IDs requiring game-theoretic interaction, ego-vehicle state information list, surrounding vehicle state information list, conflict point information, ego-vehicle posterior trajectories within the next 6 seconds, surrounding vehicle posterior trajectories within the next 6 seconds, and environment information list, and
the decision scenarios include straight driving, intersection, merge-in/merge-out, and lane change scenarios.

7. The data-driven autonomous driving decision optimization system according to claim 5, wherein the data production module comprises: a human driving data unit, a mainline sampling code encapsulation unit, a sampled trajectory feature generation unit, and an optimal trajectory calibration unit, wherein:
the human driving data unit collects and integrates massive data generated by human drivers, including ego-vehicle states and surrounding vehicle and environment information, to reflect driving styles and behavioral patterns, and
the main-line sampling code encapsulation unit encapsulates mainline sampling code according to data sampling rules and objective function constraints, automatically generating trajectory sampling schemes that satisfy the rules to obtain a preliminary rule-constrained sampled trajectory set, and
the sampled trajectory feature generation unit extracts sampled trajectory features based on trajectory sampling results, including ego and surrounding vehicle trajectory points and interaction information, generating trajectory feature vectors for analysis to obtain sampled trajectory features for subsequent model encapsulation and evaluation, and
the optimal trajectory calibration unit performs multi-objective comprehensive evaluation on sampled trajectories according to trajectory features and objective function values, calibrating optimal trajectories that satisfy objective function conditions to obtain calibrated optimal trajectories for subsequent training and validation.

8. The data-driven autonomous driving decision optimization system according to claim 5, wherein the data-screening module comprises: a scenario screening unit, a valid-frame screening unit, a key-obstacle screening unit, and a problem-category screening unit, wherein:
the scenario screening unit classifies trajectory data into scenarios such as straight driving, intersection, merge-in/merge-out according to trajectory data and scenario classification rules, provides labels for specific scenarios to obtain classified scenario datasets as a basis for refined analysis, and
the valid-frame screening unit screens key frames within effective time windows based on time-related indicators, thereby eliminating redundant data and forming a set of valid frames for high-risk scenarios, and
the key-obstacle screening unit screens key obstacle information that significantly impacts decision-making based on trajectory data and environment information, obtaining a scenario data subset containing key obstacle information, and
the problem-category screening unit screens scenario data according to scenario features and potential problem categories, focusing on solving specific driving problems to obtain high-quality training datasets optimized for problem categories.

9. The data-driven autonomous driving decision optimization system according to claim 5, wherein the model-encapsulation module comprises: a model input unit, a trajectory-pair evaluation unit configured to perform white-box evaluation, a sampled-space evaluation distribution unit, and a model output unit, wherein:
the model input unit inputs trajectory-pair features according to screened trajectory feature vectors and related parameter recommendation rules, generating a recommended parameter set adapted to the model to provide support for model accuracy and applicability, and
the trajectory-pair evaluation unit configured to perform white-box evaluation calculates evaluation parameters for trajectory pairs using a white-box model based on trajectory-pair features and the objective function, obtaining trajectory-pair white-box evaluation parameters for accurate analysis of decision effects, and
the sampled-space evaluation distribution unit . . . [wait, original has it integrated], and
the model-output unit generates a comprehensive evaluation distribution map of the sampled trajectory space based on white-box evaluation parameters and sampled-trajectory distribution, thereby describing the superiority/inferiority of trajectories under the objective function to obtain an evaluation distribution of the sampling space as a basis for parameter tuning.

10. The data-driven autonomous driving decision optimization system according to claim 5, wherein the parameter tuning module comprises: a parameter-input unit for black-box optimization, a black-box optimization unit, and an iterative parameter recommendation unit, wherein:
the parameter-input unit for black-box optimization provides initial black-box optimization input based on model input parameters and training data feature vectors as starting conditions for optimization, obtaining initial parameter configurations to initiate the optimization process, and
the black-box optimization unit adjusts parameters using a black-box optimization algorithm according to parameter configurations and optimization objective functions, gradually approaching the optimal value to obtain optimized parameter configuration results, and
the iterative parameter recommendation unit iteratively recommends parameter configurations based on intermediate results and evaluation indicators from black-box optimization, adjusting parameter combinations to improve optimization efficiency and obtain a set of recommended optimized parameters.
